(19) United States
(12) Patent Application Publication
(10) Pub. No.: US 2024/0239663 A1
(43) Pub. Date: Jul. 18, 2024

(54) CONDUCTIVE TWO-DIMENSIONAL PARTICLE AND METHOD FOR PRODUCING THE SAME

(71) Applicant: Murata Manufacturing Co., Ltd., Nagaokakyo-shi (JP)

(72) Inventor: Masashi KOYANAGI, Nagaokakyo-shi (JP)

(21) Appl. No.: 18/616,605

(22) Filed: Mar. 26, 2024

Related U.S. Application Data
(63) Continuation of application No. PCT/JP22/30048, filed on Aug. 5, 2022.

(30) Foreign Application Priority Data
Sep. 30, 2021 (JP) 2021-161527

(51) Int. Cl. C01B 32/05; C08K 3/04

(52) U.S. Cl. CPC C01B 32/05; C08K 3/04; C01P 2002/08; C01P 2002/20; C01P 2002/72; C01P 2002/82; C01P 2004/84; C01P 2006/40

(57) ABSTRACT

A conductive two-dimensional particle that includes: a plurality of layered materials each having one layer or plural layers, the one layer or plural layers including a layer body represented by: MₘXₙ, wherein M is at least one metal of Group 3-7, X is a carbon atom, a nitrogen atom, or a combination thereof, n is 1 to 4, m is more than n and 5 or less, and a modifier or terminal T on a surface of the layer body; and an oxygen atom bonding a first titanium atom of a first layered material of the plurality of layered materials to a second titanium atom of a second layered material of the plurality of layered materials, wherein the conductive two-dimensional particle does not contain a chlorine atom, an iodine atom, and a bromine atom, and has at least one of a fluorine atom, an oxygen atom, or a hydroxyl group.

### CROSS REFERENCE TO RELATED APPLICATIONS

The present application is a continuation of International application No. PCT/JP2022/030048, filed Aug. 5, 2022, which claims priority to Japanese Patent Application No. 2021-161527, filed Sep. 30, 2021, the entire contents of each of which are incorporated herein by reference.

### TECHNICAL FIELD

The present disclosure relates to a conductive two-dimensional particle and a method for producing the same.

### BACKGROUND ART

In recent years, MXene has been attracting attention as a new material. MXene is a type of so-called two-dimensional material, and as will be described later, is a layered material in the form of one or plural layers. In general, MXene is in the form of particles (which can include powders, flakes, nanosheets, and the like) of such a layered material.

Currently, various studies are being conducted toward the application of MXene to various fields. For the application, it has been studied to change the structure of MXene in order to further improve the characteristics of the material containing MXene. For example, Non-Patent Document 1 discloses a separation technique for desalination using an MXene two-dimensional membrane. In order to suppress the swelling property of the MXene two-dimensional film and to efficiently capture monovalent metal ions, it is shown that a Ti—O—Ti bond is formed between adjacent nanosheets by self-crosslinking reaction using hydroxyl groups of the MXene nanosheets.

In addition, Non-Patent Document 2 discloses that the MXene membrane is applied to ion sieving and water purification. Non-Patent Document 2 discloses that a thermally crosslinked two-dimensional MXene membrane is used in order to suppress swelling of the MXene membrane, to effectively sieve ions of a K⁺/Pb²⁺ mixture, and to enhance the efficiency of removing heavy metal ions (Pb).
Non Patent Literature 1: Self-Crosslinked MXene (Ti3C2Tx) Membranes with Good Antiswelling Property for Monovalent Metal Ion Exclusion (ACS Nano 2019, 13, 10535-10544)
Non Patent Literature 2: Voltage-enhanced ion sieving and rejection of Pb2+ through a thermally cross-linked two-dimensional MXene membrane (Chemical Engineering Journal 401 (2020) 126073)

### SUMMARY OF THE DESCRIPTION

The crosslinked MXene membranes disclosed in Non-Patent Document 1 and Non-Patent Document 2 either do not exhibit excellent electrical conductivity or have difficulty exhibiting high electrical conductivity for a long period of time, for example when applied to various electrical devices. The present disclosure has been made in view of the above circumstances, and an object of the present disclosure is to provide a conductive two-dimensional particle useful for forming a conductive film or the like exhibiting high conductivity over a long period of time, a conductive film exhibiting high conductivity over a long period of time, a method for producing the conductive two-dimensional particle, and a conductive paste and a conductive composite material containing the conductive two-dimensional particle.

According to one aspect of the present disclosure, there is provided a conductive two-dimensional particle comprising:
a plurality of layered materials each comprising: one layer or plural layers, wherein the one layer or plural layers include a layer body represented by:

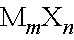

wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T existing on a surface of the layer body, wherein T is at least one selected from the group consisting of a hydroxyl group, a fluorine atom, an oxygen atom, or a hydrogen atom; and
an oxygen atom bonding a first titanium atom in the layer body of a first layered material of the plurality of layered materials to a second titanium atom in the layer body of a second layered material of the plurality of layered materials,
wherein the conductive two-dimensional particle does not contain a chlorine atom, an iodine atom, and a bromine atom, and has at least one selected from the group consisting of a fluorine atom, an oxygen atom, or a hydroxyl group.

According to another aspect of the present disclosure, there is provided a method for producing a conductive two-dimensional particle, the method comprising:
(a) preparing a precursor represented by a formula below:

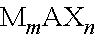

wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b) removing at least a part of A atoms from the precursor using an etching solution that does not contain a chlorine atom, an iodine atom, and a bromine atom to obtain an etched product;
(c) washing the etched product with water to obtain a water-washed product;
(d) performing an intercalation treatment with a compound for interlayer insertion, the intercalation treatment including stirring a mixed solution containing the water-washed product and the compound for interlayer insertion of the water-washed product to obtain an intercalated product;
(e) performing delamination of the intercalated product to obtain a delaminated product; and
(f) heating the delaminated product to 200° C. or higher in an inert gas atmosphere to obtain a conductive two-dimensional particle.

According to the present disclosure, there is provided a conductive two-dimensional particle which comprises one or a plurality of predetermined layers, does not contain a chlorine atom, an iodine atom, and a bromine atom, and has at least one selected from the group consisting of a fluorine atom, an oxygen atom, or a hydroxyl group, and a titanium atom in the layer body of one layer and a titanium atom in the layer body of another layer are bonded via an oxygen atom, thereby containing MXene and exhibiting high conductivity over a long period of time.

### BRIEF DESCRIPTION OF THE DRAWINGS

FIG. 1 is a schematic cross-sectional view for explaining interlayer crosslinking bond in a conductive two-dimensional particle of the present embodiment.

FIG. 2 is a schematic cross-sectional view illustrating MXene constituting the conductive two-dimensional particle of the present embodiment.

FIG. 3 is a schematic cross-sectional view illustrating a conductive film of the present embodiment.

FIG. 4 is a diagram illustrating a FT-IR analysis result in examples.

FIG. 5 is a diagram illustrating another FT-IR analysis result in examples.

FIG. 6 is a diagram illustrating an XRD profile in examples.

FIG. 7 is a diagram illustrating another XRD profile in examples.

### DETAILED DESCRIPTION OF THE PREFERRED EMBODIMENTS

### Embodiment 1: Conductive Two-Dimensional Particle

Hereinafter, a conductive two-dimensional particle in one embodiment of the present disclosure will be described in detail, but the present disclosure is not limited to such an embodiment.

A conductive two-dimensional particle of a layered material in the present embodiment comprises one layer or plural layers, wherein the one layer or plural layers include a layer body represented by:

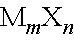

wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T existing on a surface of the layer body, wherein T is at least one selected from the group consisting of a hydroxyl group, a fluorine atom, an oxygen atom, or a hydrogen atom; and
an oxygen atom bonding a first titanium atom in the layer body of a first layered material of the plurality of layered materials to a second titanium atom in the layer body of a second layered material of the plurality of layered materials,
wherein the conductive two-dimensional particle does not contain a chlorine atom, an iodine atom, and a bromine atom, and has at least one selected from the group consisting of a fluorine atom, an oxygen atom, or a hydroxyl group.

When a conductive film is formed using the conductive two-dimensional particle, for example, the conductive two-dimensional particle can form a conductive film having a high initial conductivity and suppressed degradation of conductivity with time.

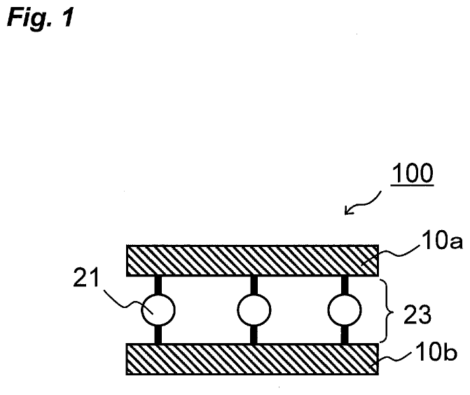

In the conductive two-dimensional particle, a titanium atom in the layer body of one layer and a titanium atom in the layer body of another layer are bonded via an oxygen atom. Hereinafter, this bond may be referred to as an “interlayer crosslinking bond.” FIG. 1 is a schematic cross-sectional view for explaining interlayer crosslinking bond in a conductive two-dimensional particle of the present embodiment. As schematically illustrated in FIG. 1, in a conductive two-dimensional particle 100, a titanium atom (not shown) of a layer body of MXene 10a in one layer and a titanium atom (not shown) of a layer body of MXene 10b in another layer are bonded via an oxygen atom 21, and a crosslinked structure 23 is formed between two layers of MXene. Although FIG. 1 illustrates a crosslinked structure between two layers of MXene for ease of explanation, the conductive two-dimensional particle of the present embodiment may also include, although not illustrated, a crosslinked structure between MXene 10a in FIG. 1 and the other MXene present above MXene 10a, and a crosslinked structure between MXene 10b in FIG. 1 and the other MXene present below MXene 10b, and may also include a case where three or more layers of MXene are bonded by a crosslinked structure. In addition, FIG. 1 illustrates a crosslinked structure between MXenes having a single layer, but at least one of MXene constituting the conductive two-dimensional particle of the present embodiment may be MXene (preferably, a few-layer MXene described later) which is a plurality of layers.

It is considered that the conductive two-dimensional particle of the present embodiment does not contain a halogen atom having a large atomic radius in the conductive two-dimensional particle, the distance between the layer body of MXene and the layer body is shortened, and many crosslinks are formed between the layer body of MXene and the layer body by heat treatment in the production process of the conductive two-dimensional particle. As a result, it is considered that the interlayer width of MXene is sufficiently narrowed, entry of water molecules is sufficiently suppressed, and moisture absorption resistance is enhanced. The crosslinked structure is considered to be formed by a dehydration reaction of hydroxyl groups on the surface of MXene. When the crosslinked structure is formed, the hydroxyl group on the surface of MXene, which is a water adsorption site, is reduced, which is also considered to contribute to improvement of moisture absorption resistance. The conductive film containing the conductive two-dimensional particle of the present embodiment, particularly the conductive film formed of the conductive two-dimensional particle of the present embodiment has high conductivity and can maintain high conductivity for a long period of time. The interlayer crosslinking bond can be determined by the presence or absence of a peak at 800 to 900 cm⁻¹ indicating a bond of a titanium atom-oxygen atom-titanium atom (Ti—O—Ti) by FT-IR (Fourier transform infrared spectroscopy) as shown in examples described later.

Hereinafter, MXene including one or plural layers constituting the conductive two-dimensional particle of the present embodiment will be described. The layered material can be understood as a layered compound and is also denoted by “MₘXₙTₛ”, in which s is an optional number, and in the related art, x or z may be used instead of s. Typically, n can be 1, 2, 3, or 4, but is not limited thereto.

In the above formula of MXene, M is preferably at least one selected from the group consisting of Ti, Zr, Hf, V, Nb, Ta, Cr, Mo, and Mn, and more preferably at least one selected from the group consisting of Ti, V, Cr, and Mo.

MXenes whose above formula MₘXₙ is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, MO₂N, Nb_{1.3}C, Mo_{1.3}Y_{0.6}C (In the above formula, “1.3” and “0.6” mean about 1.3 (=4/3) and about 0.6 (=2/3), respectively.),
Ti₃C₂, Ti₃N₂, Ti₃(CN), Zr₃C₂, (Ti, V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (MO₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃ (In the above formula, “2.7” and “1.3” mean about 2.7 (=8/3) and about 1.3 (=4/3), respectively.),

Typically in the above formula, M can be titanium or vanadium and X can be a carbon atom or a nitrogen atom. For example, the MAX phase that is a precursor of MXene is Ti₃AlC₂, and MXene is Ti₃C₂Tₛ (in other words, M is Ti, X is C, n is 2, and m is 3).

It is noted, in the present disclosure, MXene may contain remaining A atoms at a relatively small amount, for example, at 10% by mass or less with respect to the original amount of A atoms. The remaining amount of A atoms can be preferably 8% by mass or less, and more preferably 6% by mass or less. However, even if the residual amount of A atoms exceeds 10% by mass, there may be no problem depending on the application and use conditions of the electrode.

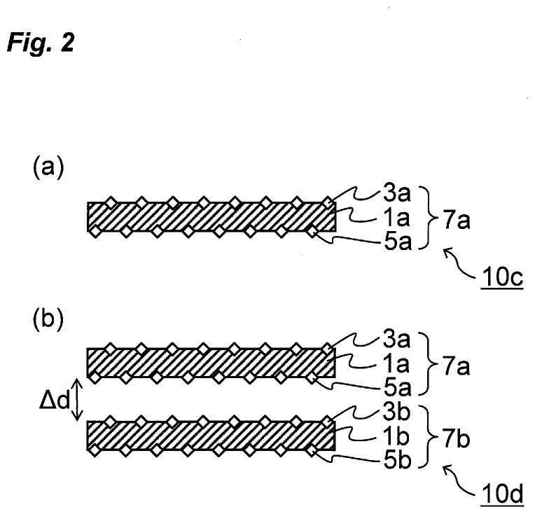

Hereinafter, MXene constituting the conductive two-dimensional particle according to the present embodiment will be described with reference to FIG. 2.

The conductive two-dimensional particle according to the present embodiment is an aggregate containing a crosslinked product of one layer of MXene 10c (single-layer MXene) schematically exemplified in FIG. 2(a), more specifically, an aggregate containing a plurality of crosslinked products in which two or more MXenes 10c are crosslinked. More specifically, MXene 10c is an MXene layer 7a having layer body (MₘXₙ layer) 1a represented by MₘXₙ, and modifier or terminals T3a and 5a existing on the surface (more specifically, at least one of two surfaces facing each other in each layer) of the layer body 1a. Therefore, the MXene layer 7a is also represented as “MₘXₙTₛ”, and s is an optional number.

In the conductive two-dimensional particle according to the present embodiment, MXene forming the crosslinked structure may be one layer or plural layers. Examples of the MXene (multilayer MXene) of the plural layers include, but are not limited to, two layers of MXene 10d as schematically illustrated in FIG. 2(b). 1b, 3b, 5b, and 7b in FIG. 2(b) are the same as 1a, 3a, 5a, and 7a in FIG. 2(a) described above. Two adjacent MXene layers (for example, 7a and 7b) of the multilayer MXene do not necessarily have to be completely separated from each other, and may be partially in contact with each other. The MXene 10c may be a mixture of the single-layer MXene 10c and the multilayer MXene 10d, in which the multilayer MXene 10d is individually separated and exists as one layer and the unseparated multilayer MXene 10d remains. Even when the multilayer MXene is included, the multilayer MXene is preferably MXene having a small number of layers obtained through the delamination treatment. The term “the number of layers is small” means that, for example, the number of stacked layers of MXene is ten or less. Hereinafter, the “multilayer MXene having a few layers” may be referred to as a “few-layer MXene” in some cases. The thickness, in the stacking direction, of the few-layer MXene is preferably 15 nm or less, and preferably 10 nm or less. In addition, the single-layer MXene and the few-layer MXene may be collectively referred to as “single-layer/few-layer MXene” in some cases.

Most of the MXene forming the crosslinked structure is preferably a single-layer/few-layer MXene. Since most of the MXene forming the crosslinked structure is a single-layer/few-layer MXene, the specific surface area of MXene can be made larger than that of the multilayer MXene, and as a result, deterioration of the conductivity over time can be further suppressed. For example, the single-layer/few-layer MXene, in which the number of stacked layers of MXene is 10 layers or less and the thickness is 15 nm or less and preferably 10 nm or less, accounts for preferably 80% by volume or more, more preferably 90% by volume or more, and still more preferably 95% by volume or more of all MXenes forming a crosslinked structure. In addition, the volume of the single-layer MXene is more preferably larger than the volume of the few-layer MXene. Since the true density of these MXenes does not greatly vary depending on the existence form, it can be said that it is more preferable that the mass of the single-layer MXene is larger than the mass of the few-layer MXene. When these relationships are satisfied, the specific surface area of MXene can be increased, and the deterioration of the conductivity over time can be further suppressed. Most preferably, the crosslinked structure is formed only of the single-layer MXene.

Although the present embodiment is not limited, the thickness of each layer of MXene (which corresponds to the MXene layers 7a and 7b) can be, for example, 1 nm to 30 μm, for example, it may be 1 nm to 5 nm, and 1 nm to 3 nm (which may mainly vary depending on the number of M atom layers included in each layer). For the individual laminates of the multilayer MXene that can be included, the interlayer distance (alternatively, a void dimension which is indicated by Δd in FIG. 2(b)) is, for example, 0.8 nm to 10 nm, particularly 0.8 nm to 5 nm, and more particularly about 1 nm, and the total number of layers can be 2 to 20,000.

The conductive two-dimensional particle does not contain a chlorine atom, an iodine atom, and a bromine atom (hereinafter, these may be collectively referred to as “halogen atom”). Since the conductive two-dimensional particle does not contain a halogen atom, crosslinking between the layer body of MXene and the layer body is easily formed in the producing process of the conductive two-dimensional particle. A conductive film containing conductive two-dimensional particles in which a layer body of MXene and a layer body are crosslinked in a large amount is superior in moisture absorption resistance and exhibits high conductivity over a long period of time to the crosslinked MXene membrane in the related art.

The phrase “does not contain a chlorine atom, an iodine atom and a bromine atom” means that the content of each atom is less than the lower limit of quantitation, that is, the content of chlorine atoms is less than 0.004% by mass, the content of iodine atoms is less than 0.04% by mass, and the content of bromine atoms is less than 0.02% by mass when measured using an ion chromatography apparatus as shown in examples described later. The content is most preferably 0% by mass.

The conductive two-dimensional particle has at least one selected from the group consisting of a fluorine atom, an oxygen atom, or a hydroxyl group. Preferably, at least one selected from the group consisting of a fluorine atom, an oxygen atom, or a hydroxyl group is included on the surface of the layer body constituting MXene. In the conductive two-dimensional particle, at least one selected from the group consisting of a fluorine atom, an oxygen atom, or a hydroxyl group having a small atomic radius is present, for example, on the surface of the layer body constituting MXene, so that the interlayer distance is narrowed, and crosslinking between the layer body of MXene and the layer body is likely to be formed in the process of producing the conductive two-dimensional particle. By forming many crosslinks between the layer body of MXene and the layer body, high moisture absorption resistance can be realized. The presence of at least one selected from the group consisting of a fluorine atom, an oxygen atom, or a hydroxyl group in the conductive two-dimensional particle can be confirmed by an XPS method as described later.

The conductive two-dimensional particle may further have a phosphate ion (PO₄³⁻) on the surface. The phosphate ion may be derived from H₃PO₄ (phosphoric acid) which is a raw material used in the step of producing conductive two-dimensional particle. By having the phosphate ion, MXene is likely to be formed into a single layer in the process of producing the conductive two-dimensional particle, and a conductive two-dimensional particle containing more single-layer/few-layer MXene is obtained. A conductive film formed using conductive two-dimensional particles containing more single-layer/few-layer MXene is preferable because it has higher conductivity. Furthermore, it may contain a phosphorus atom derived from a phosphate ion. When the conductive two-dimensional particle contains a phosphorus atom, high conductivity is easily achieved, which is preferable. In the conductive two-dimensional particle of the present embodiment, the phosphorus atom content may be 0.2% by mass to 14% by mass. The presence of phosphate ions in the conductive two-dimensional particles can be confirmed, for example, by performing high-resolution analysis (narrow scan analysis) using an X-ray photoelectron spectrometer for binding to M in the layer of MXene. The presence of the phosphorus atom in the conductive two-dimensional particle can be confirmed by an XPS method.

In the conductive two-dimensional particle, a peak of the (002) plane is preferably present at 2θ=8° or more in a profile obtained by X-ray diffraction measurement. As described above, the conductive two-dimensional particle of the present embodiment does not contain a halogen atom, a dispersant, or the like, and the distance between layers constituting MXene is shorter than that of MXene in the related art. Since the interlayer of MXene is narrow, water molecules hardly enter, and moisture absorption resistance is excellent. It can be determined from an XRD profile obtained by X-ray diffraction measurement that the interlayer of MXene is narrow. The above distance can be determined by the position of a low-angle peak of 10° (deg) or less corresponding to the (002) plane of MXene in an XRD profile obtained by X-ray diffraction measurement. The higher the peak in the XRD profile is, the narrower the interlayer distance is. In the conductive two-dimensional particle in the present embodiment, the peak of the (002) plane obtained by X-ray diffraction measurement is preferably 2θ=8.0° or more. The peak position is more preferably 8.5° or more. The upper limit of the peak position is about 9.0°. The peak refers to a peak top. The X-ray diffraction measurement may be performed under the conditions shown in examples to be described later. The object to be measured may be a conductive two-dimensional particle, or may be a conductive film containing the conductive two-dimensional particle.

### Embodiment 2: Method for Producing Conductive Two-Dimensional Particle

Hereinafter, a method for producing a conductive two-dimensional particle in the embodiment of the present disclosure will be described in detail, but the present disclosure is not limited to such an embodiment.

A method for producing a conductive two-dimensional particle of the present embodiment, the method comprises
(a) preparing a precursor represented by:

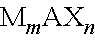

wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b) performing an etching of removing at least a part of A atoms from the precursor by using an etching solution that does not contain a chlorine atom, an iodine atom, and a bromine atom;
(c) washing an etched product obtained by etching with water to obtain a water-washed product;
(d) performing an intercalation treatment of a compound for interlayer insertion, the intercalation treatment including stirring a mixed solution containing the water-washed product and the compound for interlayer insertion of the water-washed product;
(e) performing delamination using an intercalated product obtained by the intercalation treatment; and
(f) performing a heat treatment of heating a delaminated product obtained by performing the delamination to 200° C. or higher in an inert gas atmosphere to obtain a conductive two-dimensional particle. By this producing method, it is possible to produce conductive two-dimensional particles which are optimal for producing conductive films and the like exhibiting high conductivity for a long period of time.

Hereinafter, each step of the producing method will be described in detail.

### Step (a)

First, a predetermined precursor is prepared. A predetermined precursor that can be used in the present embodiment is a MAX phase that is a precursor of MXene, and is represented by a formula below:

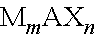

wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less.

The above M, X, n, and m are as described in MXene. A is at least one element of Group 12, 13, 14, 15, or 16, is usually a Group A element, typically Group IIIA and Group IVA, more specifically, may include at least one selected from the group consisting of Al, Ga, In, Tl, Si, Ge, Sn, Pb, P, As, S, and Cd, and is preferably Al.

The MAX phase has a crystal structure in which a layer constituted by A atoms is located between two layers represented by MₘXₙ (each X may have a crystal lattice located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms.

The MAX phase can be produced by a known method. For example, a TiC powder, a Ti powder, and an Al powder are mixed in a ball mill, and the obtained mixed powder is calcined under an Ar atmosphere to obtain a calcined body (block-shaped MAX phase). Thereafter, the calcined body obtained is pulverized by an end mill to obtain a powdery MAX phase for the next step.

### Step (b)

Etching for removing at least a part of A atoms from the precursor is performed using an etching solution containing no chlorine atom, iodine atom, or bromine atom. The etching solution used in the producing method of the present embodiment does not contain a chlorine atom, an iodine atom, and a bromine atom. That is, for example, acids such as HCl, HI, and HBr, other chlorides, iodides, and bromides are not contained. The etching solution contains at least hydrofluoric acid. The etching solution preferably further contains one or more of phosphoric acid and sulfuric acid, and more preferably further contains phosphoric acid. For example, it is also possible to perform etching by a so-called MILD method in which HCl and LiF contained in the etching solution are reacted in a system to generate HF, but preferably, a so-called ACID method in which etching is performed with an etching solution containing HF (hydrofluoric acid), or a method in which etching is performed with an etching solution further containing phosphoric acid is preferable. According to these methods, as compared with the MILD method, particles (MXene particles) of a flaky layered material having a large flat region with a number-average value of a ferret diameter of preferably 3 μm or more can be easily obtained, which is preferable. Other conditions for etching are not particularly limited, and known conditions can be adopted. As the etching solution, a mixed solution of the acid and, for example, pure water as a solvent may be used. The HF concentration in the etching solution is, for example, 1.5 M to 14 M, the H₃PO₄ concentration is, for example, 5.5 M or more, and the H₂SO₄ concentration is, for example, 5.0 M or more. In the etching of the A atoms, a part of the M atoms may be selectively etched together with the A atoms. Examples of the etched product obtained by the etching include slurry.

### Step (c)

The etched product obtained by the etching is washed with water. By performing water washing, the acid and the like used in the etching can be sufficiently removed. The amount of water mixed with the etched product and the washing method are not particularly limited. For example, stirring, centrifugation, and the like may be performed by adding water. Examples of the stirring method include stirring using a handshake, an automatic shaker, a share mixer, a pot mill, or the like. The degree of stirring such as stirring speed and stirring time may be adjusted according to the amount, concentration, and the like of the object to be treated. The washing with water may be performed one or more times. Preferably, washing with water is performed multiple times. For example, specifically, steps (i) to (iv) of (i) adding water and (ii) stirring (to the etched product or the remaining precipitate obtained in the following (iv)), (iii) centrifuging the stirred product, and (iv) discarding the supernatant after centrifugation and recovering the remaining precipitate are performed within a range of 2 times or more, for example, 15 times or less.

### Step (d)

The intercalation treatment of the compound for interlayer insertion is performed including stirring a mixed solution containing the water-washed product and the compound for interlayer insertion of the water-washed product.

The compound for interlayer insertion of water treatment product may be of any specific type as long as it is a compound that can be inserted between the layers of the water treatment product and can separate the water treatment product into the respective layers by the delamination in the next step (e). The compound for interlayer insertion is preferably an alkali metal compound or an alkaline earth metal compound. A Li-containing compound is more preferable. As the Li-containing compound, an ionic compound in which a Li ion and a cation are bonded can be used. Examples of the Li ions include a hydroxide, a phosphate, a sulfide salt including a sulfate, a nitrate, an acetate, and a carboxylate. It is preferably a hydroxide, and more preferably lithium hydroxide.

Other conditions of the intercalation treatment are not particularly limited. The liquid property of the mixed solution containing the water-washed product and the compound for interlayer insertion of the water-washed product is not limited. The mixed solution containing the water-washed product and the compound for interlayer insertion of the water-washed product is preferably alkaline. The pH of the mixed solution is preferably in the range of 8 to 14. The method for making the mixed solution alkaline is not limited, and examples thereof include a mixed solution containing a hydroxide as a compound for interlayer insertion, preferably lithium hydroxide as a Li-containing compound, and a mixed solution containing a compound for interlayer insertion and a hydroxide such as ammonia, potassium hydroxide, sodium hydroxide, calcium hydroxide, or magnesium hydroxide as a pH adjusting agent.

The content of the compound for interlayer insertion in the intercalation formulation is preferably 0.001% by mass or more. The content is more preferably 0.01% by mass or more, and still more preferably 0.1% by mass or more. On the other hand, from the viewpoint of dispersibility in a solution, the content of the compound for interlayer insertion is preferably 10% by mass or less, and more preferably 1% by mass or less.

The specific method of intercalation is not particularly limited, and for example, the compound for interlayer insertion may be mixed with a moisture medium clay of MXene and stirred, or may be allowed to stand. For example, stirring at room temperature can be mentioned. Examples of the stirring method include a method using a stirring bar such as a stirrer, a method using a stirring blade, a method using a mixer, and a method using a centrifugal device. The stirring time can be set according to the producing scale of the electrode, and may be, for example, set to 12 to 24 hours.

### Step (e)

Delamination is performed using the intercalated product obtained by intercalation. For example, delamination includes a step of centrifuging the intercalated product and washing the remaining precipitate with water after discarding the supernatant. The conditions for delamination treatment are not particularly limited. The dispersion medium used for delamination is not particularly limited, and examples thereof include performing delamination using one or more of a polar organic dispersion medium and an aqueous dispersion medium. Examples of the polar organic dispersion mediums include polar organic dispersion mediums having a boiling point of 285° C. or lower and one or more of a carbonyl group, an ester group, an amide group, a formamide group, a carbamoyl group, a carbonate group, an aldehyde group, an ether group, a sulfonyl group, a sulfinyl group, a hydroxyl group, a cyano group, and a nitro group. More specific examples of the polar organic dispersion mediums include one or more of methanol (MeOH), ethanol (EtOH), dimethyl sulfoxide (DMSO), propylene carbonate (PC), N methylformamide (NMF), acetone, methyl ethyl ketone (MEK), tetrahydrofuran (THF), acetonitrile, N methylacetamide (NMAc), N,N dimethylformamide (DMF), N,N dimethylacetamide (DMAC), sulfolane, and N-methylpyrrolidone (NMP). The aqueous dispersion medium is typically water, and in some cases, other liquid substances may be contained in a relatively small amount (for example, 30% by mass or less, preferably 20% by mass or less based on the whole mass) in addition to water. For example, a plurality of times of stirring in delamination may be performed with a polar organic dispersion medium and an aqueous dispersion medium. For example, adding a polar organic dispersion medium such as N-methylformamide (NMF) to the intercalated product and stirring the mixture, then adding an aqueous dispersion medium and stirring the mixture, and centrifuging the mixture to recover the supernatant may be repeated once or more, preferably twice to 10 times to obtain the supernatant containing the single-layer/few-layer MXene as the delaminated product. Alternatively, the supernatant may be centrifuged, and the supernatant after centrifugation may be discarded to obtain a single-layer/few-layer MXene-containing clay as a delaminated product.

### Step (f)

The delaminated product obtained by performing the delamination is subjected to a heat treatment of heating to 200° C. or higher in an inert gas atmosphere to obtain a conductive two-dimensional particle. The temperature of the heat treatment is preferably 300° C. or higher, and more preferably 400° C. or higher. The temperature of the heat treatment can be, for example, 700° C. or lower. The atmosphere of the heat treatment is an inert gas atmosphere such as argon or nitrogen. The pressure during the heat treatment is also not particularly limited, and may be normal pressure or vacuum. In the present embodiment, by annealing MXene not containing a steric large element such as chlorine at a high temperature without being oxidized, it is possible to realize crosslinked MXene having a narrow interlayer and significantly improved moisture absorption resistance (reliability), which cannot be realized by the crosslinked MXene in the related art.

### Embodiment 3: Conductive Film

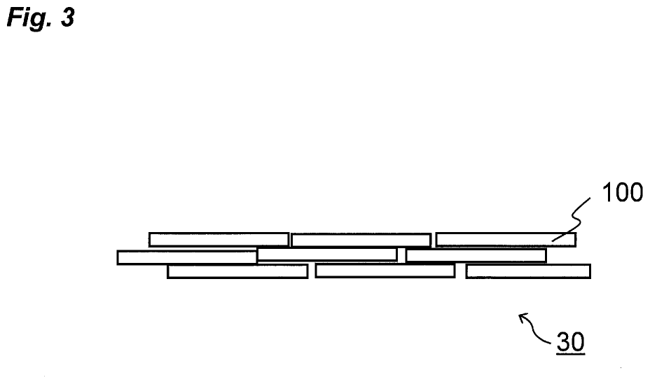

Examples of the conductive film of the present embodiment include a conductive film (crosslinked MXene film) containing conductive two-dimensional particles of the present embodiment. Referring to FIG. 3, the conductive film of the present embodiment will be described. FIG. 3 illustrates the conductive film 30 obtained by stacking only the conductive two-dimensional particles 100. The conductive film of the present embodiment is not limited thereto.

The conductive film may be a conductive composite material film (conductive composite material film) further containing a polymer (resin). The polymer may be contained, for example, as an additive such as a binder added at the time of film formation, or may be added for providing strength or flexibility. In a case of the conductive composite material film, the proportion of the polymer in the conductive composite material film (when dried) may be more than 0% by volume and preferably 30% by volume or less. The proportion of the polymer may be further 10% by volume or less, and further 5% by volume or less. In other words, the proportion of the conductive two-dimensional particles (particles of the layered material) in the conductive composite material film (when dried) is preferably 70% by volume or more, more preferably 90% by volume or more, and still more preferably 95% by volume or more. The conductive film may be a stacked film of two or more conductive composite material films having different proportions of the conductive two-dimensional particles.

Examples of the polymer include a hydrophilic polymer (hydrophilicity is exhibited by mixing a hydrophilic auxiliary agent in a hydrophobic polymer, and a hydrophilization treatment of a surface of a hydrophobic polymer or the like is included), and the hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, and nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, and nylon are preferably used.

Among these, one or more polymers selected from the group consisting of water-soluble polyurethane, polyvinyl alcohol, and sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

The film thickness of the conductive film is preferably 0.5 μm to 20 μm. By increasing the film thickness of the conductive film, the contact resistance of the grain boundary is reduced, and the conductivity tends to be increased, and thus the film thickness is preferably 0.5 μm or more. The film thickness is more preferably 1.0 μm or more. The film thickness is preferably as large as possible from the viewpoint of conductivity, but when flexibility or the like is required, the film thickness is preferably 20 μm or less, and more preferably 15 μm or less. The thickness of the conductive film can be measured by, for example, measurement with a micrometer, cross-sectional observation by a method such as a scanning electron microscope (SEM), a microscope, or a laser microscope.

The conductive film of the present embodiment preferably maintains a conductivity of 5,000 S/cm or more, for example, when the conductive film has a sheet shape formed of the conductive two-dimensional particles and having a film thickness of 10 μm. The conductivity can be achieved as conductivity of more preferably 5,500 S/cm to still more preferably 6,000 S/cm or more. The conductivity of the conductive film is not particularly limited, and may be, for example, 10,000 S/cm or less. The conductivity can be determined as follows. That is, the surface resistivity is measured by a four-point probe method, a value obtained by multiplying the thickness [cm] by the surface resistivity [Ω/□] is the volume resistivity [Ω·cm], and the conductivity [S/cm] can be obtained as the reciprocal thereof.

### (Method for Producing Conductive Film)

A method for producing a conductive film of the present embodiment using conductive two-dimensional particles produced as described above is not particularly limited. For example, as exemplified below, a conductive film can be formed.

First, a dispersion of the conductive two-dimensional particle in which the conductive two-dimensional particles prepared as described above are present in a medium liquid is prepared. Examples of the medium liquid include an aqueous medium liquid and an organic medium liquid. The medium liquid constituting the dispersion of the conductive two-dimensional particle is typically water, and in some cases, other liquid substances may be contained in a relatively small amount (for example, 30% by mass or less, preferably 20% by mass or less based on the whole mass) in addition to water.

Before drying, a precursor of a conductive film (also referred to as a “precursor film”) may be formed using the dispersion of the conductive two-dimensional particle. The method for forming the precursor is not particularly limited, and for example, coating, suction filtration, spray, or the like can be used.

More specifically, as the dispersion of the conductive two-dimensional particle, for example, a supernatant containing conductive two-dimensional particles is appropriately adjusted (for example, diluted with an aqueous medium liquid), and is subjected to suction filtration through a filter (which may constitute a predetermined member together with the conductive film, or may be finally separated from the conductive film) installed in a nutsche or the like. Thereby, the aqueous medium liquid is at least partially removed, so that a precursor can be formed on the filter. The filter is not particularly limited, but a membrane filter or the like can be used. By performing the suction filtration, a conductive film can be produced without using the binder or the like. When the conductive two-dimensional particles of the present embodiment are used, a conductive film can be produced without using a binder or the like as described above.

Alternatively, the dispersion of the conductive two-dimensional particle may be applied to the substrate as it is or after being appropriately adjusted (for example, dilution with an aqueous medium liquid, or addition of a binder). Examples of the coating method include a spray coating method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating, dip coating, or dropping. As a substrate, for example, a substrate formed of a metal material, a resin, or the like suitable for the biosignal sensing electrode can be appropriately adopted as the substrate. By coating onto any suitable substrate (which may constitute a predetermined member together with the conductive film, or may be finally separated from the conductive film), a precursor film can be formed on the substrate.

Next, the precursor film formed as described above is dried to obtain, for example, a conductive film 30 as schematically illustrated in FIG. 3. In the present disclosure, the “drying” means removing the aqueous medium liquid that can exist in the precursor.

Drying may be performed under mild conditions such as natural drying (typically, it is disposed in an air atmosphere at normal temperature and normal pressure) or air drying (blowing air), or may be performed under relatively active conditions such as hot air drying (blowing heated air), heat drying, and/or vacuum drying. The drying may be performed, for example, at a temperature of 400° C. or lower using a normal pressure oven or a vacuum oven.

The forming and drying the precursor film may be appropriately repeated until a desired conductive film thickness is obtained. For example, a combination of spraying and drying may be repeated a plurality of times.

As another method for producing a conductive film, as shown in examples described later, a pre-crosslinking conductive film may be formed using pre-crosslinking conductive two-dimensional particles, and then heat treatment may be performed to obtain a conductive film. The formation of the pre-crosslinking conductive film using the pre-crosslinking conductive two-dimensional particles and the heat treatment may be performed under the conditions described above.

When the conductive composite material of the present embodiment has a sheet-like form, for example, as illustrated below, the conductive two-dimensional particles and the polymer can be mixed to form a coating film.

First, a dispersion of the conductive two-dimensional particle in which the conductive two-dimensional particles are present in a medium liquid (one or more of an aqueous medium liquid and an organic medium liquid) or powdery conductive two-dimensional particles may be mixed with a polymer. The medium liquid constituting the dispersion of the conductive two-dimensional particle is typically water, and in some cases, other liquid substances may be contained in a relatively small amount (for example, 30% by mass or less, preferably 20% by mass or less based on the whole mass) in addition to water.

The stirring of the conductive two-dimensional particles and the polymer can be performed using a dispersing device such as a homogenizer, a propeller stirrer, a thin film swirling stirrer, a planetary mixer, a mechanical shaker, or a vortex mixer.

A slurry which is a mixture of the conductive two-dimensional particle and the polymer may be applied to a substrate (for example, a substrate), but the application method is not limited. Examples of the coating method include a spray coating method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating, dip coating, or dropping. As a substrate, for example, a substrate formed of a metal material, a resin, or the like suitable for the biosignal sensing electrode can be appropriately adopted as the substrate.

The coating and drying may be repeated a plurality of times as necessary until a film having a desired thickness is obtained. The drying and curing may be performed, for example, at a temperature of 400° C. or lower using a normal pressure oven or a vacuum oven.

### Embodiment 4: Conductive Paste

Examples of other applications of using the conductive two-dimensional particles of the present embodiment include a conductive paste containing the conductive two-dimensional particles. Examples of the conductive paste include a mixture of conductive two-dimensional particles and a medium. Examples of the medium include an aqueous medium liquid, an organic medium liquid, a polymer, metal particles, and ceramic particles, and examples thereof include those containing one or more of these. The mass ratio of the conductive two-dimensional particles in the conductive paste is, for example, 50% or more.

Examples of the application include forming a conductive film by applying the conductive paste onto a substrate or the like and drying the paste.

### Embodiment 5: Conductive Composite Material

Examples of other applications of using the conductive two-dimensional particles of the present embodiment include a conductive composite material containing the conductive two-dimensional particles and a polymer. The conductive composite material is not limited to the shape of the conductive composite material film (conductive composite material film) described above. The shape of the conductive composite material may be a shape having thickness, a rectangular parallelepiped, a sphere, a polygon, or the like, other than the film shape.

As the polymer, a polymer similar to the polymer used for the conductive composite material film (conductive composite material film) can be used. For example, it may be contained as an additive such as a binder added at the time of film formation, or may be added for providing strength or flexibility. The proportion of the polymer in the conductive composite material (when dried) may be more than 0% by volume and preferably 30% by volume or less. The proportion of the polymer may be further 10% by volume or less, and further 5% by volume or less. In other words, the proportion of the particles of the layered material in the conductive composite material (when dried) is preferably 70% by volume or more, more preferably 90% by volume or more, and still more preferably 95% by volume or more.

Examples of the polymer include a hydrophilic polymer (hydrophilicity is exhibited by mixing a hydrophilic auxiliary agent in a hydrophobic polymer, and a hydrophilization treatment of a surface of a hydrophobic polymer or the like is included), and the hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, and nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, and nylon are preferably used.

Among these, one or more polymers selected from the group consisting of water-soluble polyurethane, polyvinyl alcohol, and sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

Although the conductive two-dimensional particle, the method for producing the conductive two-dimensional particle, the conductive film, the conductive paste, and the conductive composite material in the embodiments of the present disclosure have been described in detail above, various modifications are possible. It should be noted that the conductive two-dimensional particle according to the present disclosure may be produced by a method different from the producing method in the above-described embodiment, and the method for producing a conductive two-dimensional particle of the present disclosure is not limited only to one that provides the conductive two-dimensional particle according to the above-described embodiment.

### EXAMPLES

### [Preparation of Sample]

### Examples 1 to 5, Comparative Examples 1 to 5

In the present embodiment, the pre-crosslinking conductive two-dimensional particle is heat-treated to obtain the conductive two-dimensional particle of the present embodiment, that is, the crosslinked conductive two-dimensional particle. In the present embodiment, the pre-crosslinking conductive film is formed using the pre-crosslinking conductive two-dimensional particle, and then heat-treated to obtain the crosslinked conductive film, that is, the conductive film formed of the conductive two-dimensional particle of the present embodiment.

In Examples 1 to 5, steps of (1) preparation of the precursor (MAX), (2) etching of the precursor, (3) washing after etching, (4) intercalation of Li, (5) delamination, and (6) formation and heat treatment of a film using pre-crosslinking conductive two-dimensional particles described below in detail were performed in this order to obtain a sample. In Comparative Examples 1 to 5, a sample was obtained up to the formation of the film.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The calcined body (block-shaped MAX) thus obtained was pulverized with an end mill to a maximum dimension of 40 μm or less. In this way, Ti₃AlC₂ particles were obtained as a precursor (powdery MAX).

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieving with a mesh size of 45 μm)
Etching solution composition: composition shown in the following Table 1, provided that a reagent having a concentration of 48% is used for hydrofluoric acid, and a reagent having a concentration of 85% is used for phosphoric acid
Amount of precursor input: 3.0 g
Reaction container: 100 ml bottle made of polypropylene (Eyeboy)
Etching temperature: 35° C.
Etching time: 24 h
Stirrer rotation speed: 400 rpm

TABLE 1

| | Hydrofluoric | Phosphoric | Pure |
|---|---|---|---|
| | acid | acid | water |
| | (mL) | (mL) | (mL) |
| Example 1, | 6 | 0 | 54 |
| Comparative Example 1 | | | |
| Example 2, | 18 | 0 | 42 |
| Comparative Example 2 | | | |
| Example 3, | 30 | 0 | 30 |
| Comparative Example 3 | | | |
| Example 4, | 60 | 0 | 0 |
| Comparative Example 4 | | | |
| Example 5, | 14 | 15 | 30 |
| Comparative Example 5 | | | |

(3) Washing after Etching

The slurry was equally divided into two portions and inserted into two 50 mL centrifuge tubes. Thereafter, the mixture was centrifuged at 3500 G for 5 minutes using a centrifuge, and then the supernatant was discarded. Thereafter, (i) 35 mL of pure water was added to the remaining precipitate in each centrifuge tube, (ii) stirring was performed by handshake, (iii) centrifugation was performed at 3500 G for 5 minutes, and (iv) the supernatant was removed. The steps (i) to (iv) were repeated 10 times. Finally, centrifugation was performed at 3500 G for 5 minutes to obtain a Ti₃C₂Tₛ-moisture medium clay.

### (4) Li Intercalation

The Ti₃C₂Tₛ-moisture medium clay prepared by the above method was stirred under the following conditions to intercalate Li ions.

### (Conditions of Li Intercalation)

Ti₃C₂Tₛ-moisture medium clay (MXene after washing): solid content 0.75 g
Pure water: 20 mL
Li ion source: 15 mL of pure water+0.75 g of LiOH
Reaction container: 100 ml bottle made of polypropylene (Eyeboy)
Temperature: 20° C. to 25° C. (room temperature)
Stirring time: 18 hours
Stirring rotation speed: 700 rpm

After completion of the stirring, the mixture was transferred to a 50 mL centrifuge tube, centrifuged under the condition of 3500 G using a centrifuge for 5 minutes, and then the supernatant was discarded. Thereafter, (i) 35 mL of pure water was added to the remaining precipitate in the centrifuge tube, (ii) the mixture was stirred with a handshake, (iii) the mixture was centrifuged at 3500 G for 5 minutes, and (iv) the supernatant was removed. The steps (i) to (iv) were repeated five times. Finally, centrifugation was performed at 3500 G for 5 minutes to obtain a Li intercalated product.

### (5) Delamination

The Li intercalated product was delaminated under the following conditions.

### (Delamination Conditions)

MXene (Li intercalated product) after intercalation: 0.75 g of solid content
Solvent: 15 mL of NMF
Reaction container: 100 ml bottle made of polypropylene (Eyeboy)
Temperature: 20° C. to 25° C. (room temperature)
Stirring time: 18 hours
Stirring: 700 rpm

After the above stirring, 15 mL of pure water was added, and the mixture was stirred with a shaker for 15 minutes, and then centrifuged at 3500 G for 5 minutes using a centrifuge to recover a supernatant containing MXene formed into a single layer. Further, 30 mL of pure water was added, and the mixture was stirred with a shaker and then centrifuged in the same manner as described above. After that, the obtained supernatant was recovered and centrifuged under the conditions of 4000 G for 2 hours using a centrifuge, and then the supernatant was discarded to obtain a single-layer/few-layer MXene (pre-crosslinking conductive two-dimensional particle) as a remaining precipitate.

### (6) Formation and Heat Treatment of Film Using Pre-Crosslinking Conductive Two-Dimensional Particle

The clay of the pre-crosslinking conductive two-dimensional particle obtained by the delamination was subjected to suction filtration. As a filter for suction filtration, a membrane filter (Durapore, manufactured by Merck KGaA, pore size 0.45 μm) was used. The supernatant contained 0.05 g of solid content of MXene two-dimensional particles and 40 mL of pure water. After the filtration, in Examples 1 to 5, vacuum drying at 80° C. was performed for 24 hours, and then annealing (heat treatment) was performed at 500° C. in an inert (nitrogen) atmosphere to obtain a sample. On the other hand, in Comparative Examples 1 to 5, a film was formed in the same manner as in Examples 1 to 5, vacuum drying was performed at 80° C. for 24 hours, and a sample was obtained without performing heat treatment. That is, Example 1 and Comparative Example 1, Example 2 and Comparative Example 2, Example 3 and Comparative Example 3, Example 4 and Comparative Example 4, and Example 5 and Comparative Example 5 are the same until the film (MXene film before crosslinking) is produced, and the presence or absence of the heat treatment is different.

### Comparative Examples 6 and 7

In Comparative Example 7, steps of (1) preparation of the precursor (MAX), (2) etching of the precursor and Li intercalation, (3) washing, (4) delamination, and (5) formation and heat treatment of a film using MXene particles described below in detail were performed in this order to obtain a sample. In Comparative Example 6, a sample was obtained up to the formation of the film.

### (1) Preparation of Precursor (MAX): Same as Examples 1 to 5

### (2) Etching of Precursor and Intercalation of Li

Precursor: Ti₃AlC₂ (sieving with a mesh size of 45 μm)
Etching solution composition: 3 g of LiF
   30 mL of HCl (9 M)
Amount of precursor input: 3 g
Etching container: 100 ml bottle made of polypropylene (Eyeboy)
Etching temperature: 35° C.
Etching time: 24 h
Stirrer rotation speed: 400 rpm

### (3) Washing

The slurry was divided into two portions, each of which was inserted into two 50 mL centrifuge tubes, centrifuged under the condition of 3500 G using a centrifuge, and then the supernatant was discarded. (i) 40 mL of pure water was added to the remaining precipitate in each centrifuge tube and (ii) centrifuged again at 3500 G to (iii) separate and remove the supernatant. The operations (i) to (iii) were repeated 10 times in total, it was confirmed that the pH of the 10th supernatant was more than 5, and the supernatant was discarded to obtain a Ti₃C₂Tₛ-moisture medium clay.

### (4) Delamination

Next, (i) 40 mL of pure water was added to the Ti₃C₂Tₛ-moisture medium clay, and the mixture was stirred for 15 minutes with a shaker, then (ii) centrifuged at 3500 G, and (iii) the supernatant was recovered as a single-layer MXene-containing liquid. The operations (i) to (iii) were repeated 4 times in total to obtain a single-layer MXene-containing supernatant. Further, this supernatant was centrifuged under the conditions of 4300 G and 2 hours using a centrifuge, and then the supernatant was discarded to obtain a single-layer/few-layer MXene-containing clay as a single-layer/few-layer MXene-containing sample.

### [Preparation and Heat Treatment of MXene Film Before Crosslinking]

The clay of the pre-crosslinking conductive two-dimensional particle obtained by the delamination was subjected to suction filtration. As a filter for suction filtration, a membrane filter (Durapore, manufactured by Merck KGaA, pore size 0.45 μm) was used. The supernatant contained 0.05 g of solid content of MXene two-dimensional particles and 40 mL of pure water. After the filtration, in Comparative Example 6, vacuum drying was performed at 80° C. for 24 hours, and a sample was obtained without performing heat treatment. Also, in Comparative Example 7, vacuum drying at 80° C. was performed for 24 hours, and then annealing (heat treatment) was performed at 500° C. in an inert (nitrogen) atmosphere to obtain a sample.

### [Evaluation]

Using the samples (crosslinked MXene film) of Examples 1 to 5, the samples (non-crosslinked MXene film) of Comparative Examples 1 to 6, and the sample (crosslinked MXene film) of Comparative Example 7, the measurement of the crosslinked structure, the composition analysis of the surface group of the MXene particles, the measurement of the MXene interlayer distance, and the measurement of the initial conductivity and σ/σ₀ of each MXene film were performed. Details of each measurement method will be described below.

### (Measurement of Crosslinked Structure (FT-IR Analysis))

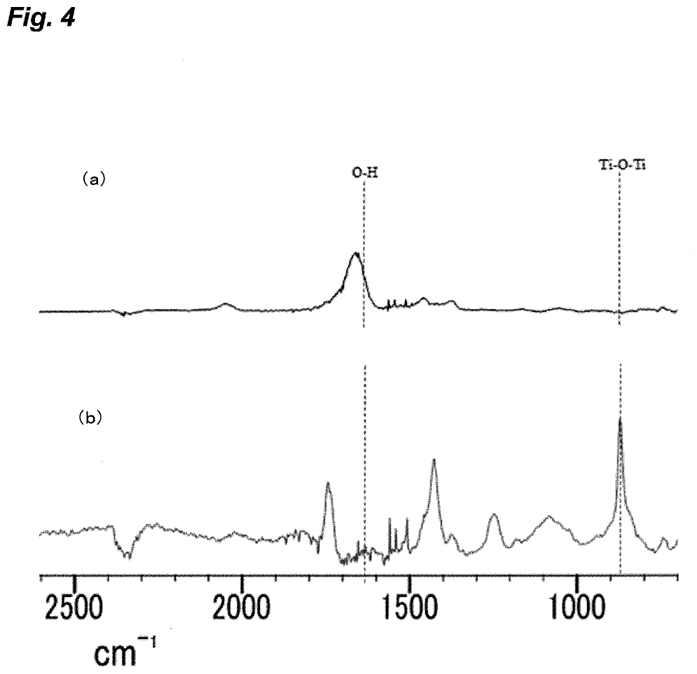

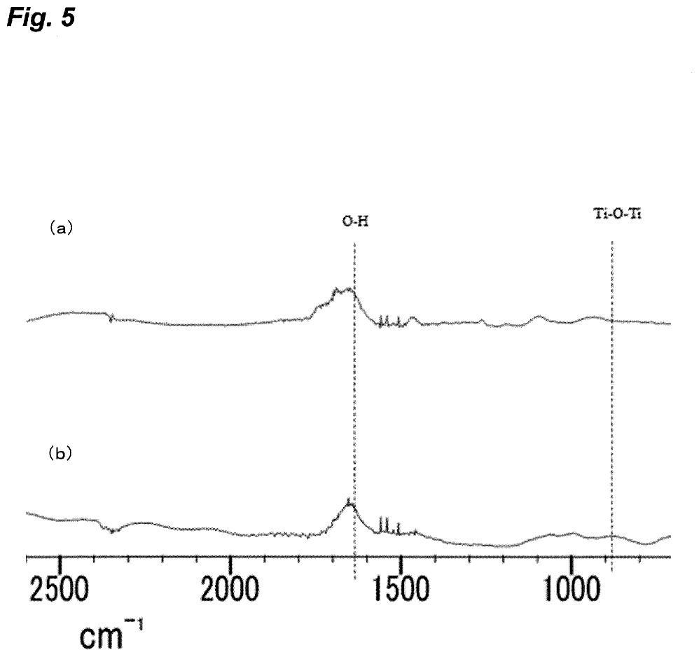

The structures of the sample (crosslinked MXene film) of Example 3, the sample (non-crosslinked MXene film) of Comparative Example 3, the sample (non-crosslinked MXene film) of Comparative Example 6, and the sample (crosslinked MXene film) of Comparative Example 7 were confirmed using an FT-IR apparatus manufactured by Agilent Technologies. The results are illustrated in FIG. 4(a) for Comparative Example 3, FIG. 4(b) for Example 3, FIG. 5(a) for Comparative Example 6, and FIG. 5(b) for Comparative Example 7. From these drawings, in Example 3, interlayer crosslinking bond of a titanium atom-oxygen atom-titanium atom (Ti—O—Ti) could be confirmed. On the other hand, in Comparative Example 3, Comparative Example 6, and Comparative Example 7, the interlayer crosslinking bond could not be confirmed. In addition, in Comparative Example 3, Comparative Example 6 and Comparative Example 7, a peak of a hydroxyl group was clearly confirmed, but in Example 3, a peak of a hydroxyl group was not confirmed. From these facts, it is considered that in Example 3, an interlayer crosslinking bond of titanium atom-oxygen atom-titanium atom (Ti—O—Ti) was formed by a dehydration reaction of hydroxyl groups on the surface of MXene.

### (Composition Analysis of Surface Group of MXene Particle)

The compositions of the surface groups of the MXene particles in the samples (crosslinked MXene films) of Examples 1 to 5 and the sample (crosslinked MXene film) of Comparative Example 7 were determined by performing XPS measurement under the following conditions using an X-ray photoelectron spectrometer (product name: VersaProbe) manufactured by ULVAC-PHI, INCORPORATED. The results are shown in Table 2. The amounts of chlorine atoms, iodine atoms, and bromine atoms in Examples 1 to 5 were all at the lower detection limit by ion chromatography (IC) (Dionex ICS-5000 manufactured by Thermo Fisher Scientific). That is, all the atoms were smaller than the lower limit of quantification (lower limit of quantification of Cl: 0.004% by mass, lower limit of quantification of Br: 0.02% by mass, lower limit of quantification of I: 0.04% by mass) of each atom in the ion chromatography.

### (XPS Measurement Conditions)

Incident X-ray: monochromatic AlKα
X-ray output: 25.6 W
Measurement area: diameter 100 μm
Photoelectron take-in angle: 45.0 degrees
Pass energy: 23.50 eV

TABLE 2

| | Presence or | Presence or | | | | | | |
|---|---|---|---|---|---|---|---|---|
| | absence of halogen | absence of heat | Surface element composition (atomic %) | | | | | |
| Samples | in etching solution | treatment | C | O | F | P | Cl | Ti |
| Example 1 | Absence | Presence | 49.5 | 22.9 | 7.5 | — | — | 20.1 |
| Example 2 | Absence | Presence | 49.9 | 22.9 | 7.3 | — | — | 19.9 |
| Example 3 | Absence | Presence | 48.1 | 22.6 | 8.5 | — | — | 20.8 |
| Example 4 | Absence | Presence | 49.7 | 22.4 | 8.3 | — | — | 19.6 |
| Example 5 | Absence | Presence | 44.5 | 31 | 5.5 | 5.2 | — | 13.8 |
| Comparative | Presence | Presence | 47.1 | 17.4 | 9.1 | — | 3.4 | 23 |
| Example 7 | | | | | | | | |

Table 2 shows the composition analysis of the surface group of Examples 1 to 5, but it is considered that the composition analysis of the surface group of the MXene particles is similar to that of Examples 1 to 5 also in Comparative Examples 1 to 5 in which the method for producing the MXene particles is the same as that in Examples 1 to 5.

### (Measurement of MXene Interlayer Distance)

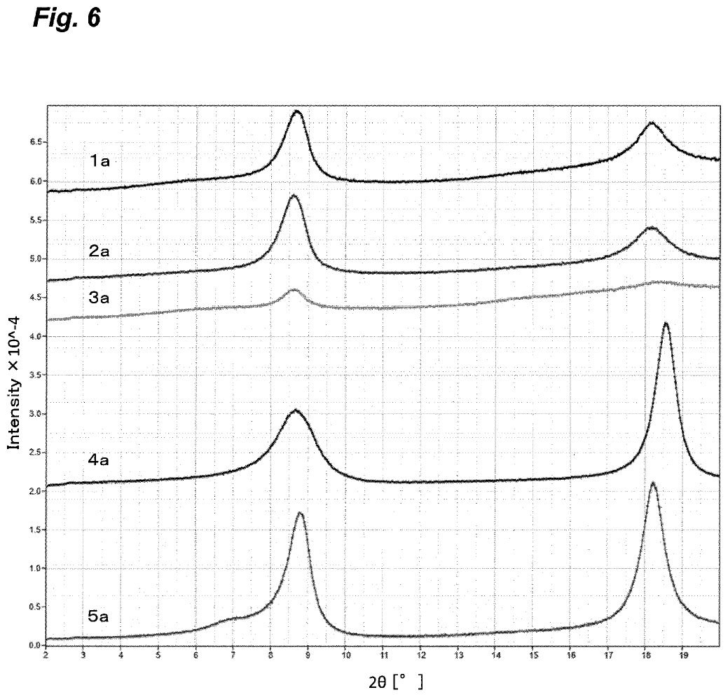

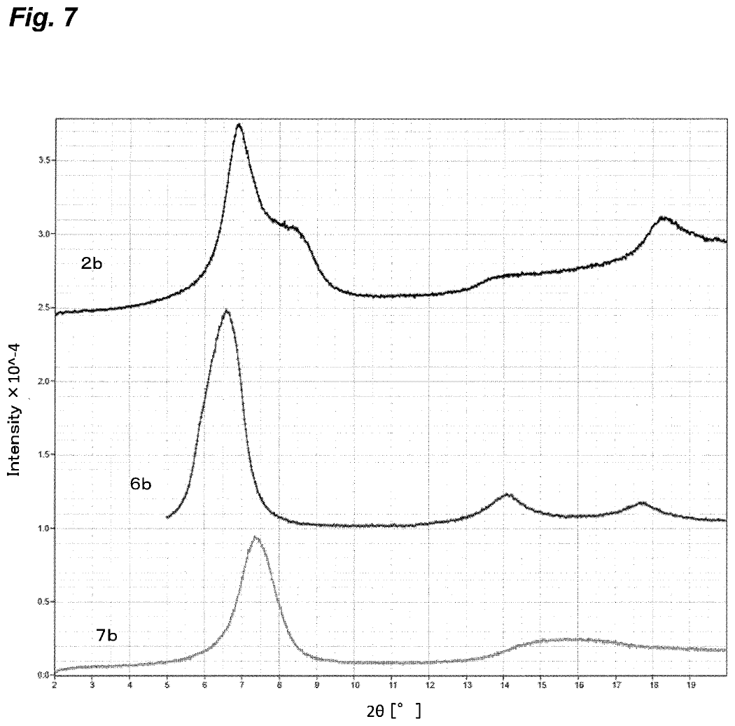

The interlayer distance of MXene can also be measured using conductive two-dimensional particles, but in this example, the interlayer distance of MXene was measured using an MXene film. More specifically, the samples (crosslinked MXene film or non-crosslinked MXene films) of Examples 1 to 5, Comparative Example 2, Comparative Example 6, and Comparative Example 7 were subjected to XRD measurement under the following conditions to obtain two-dimensional X-ray diffraction images. Then, the peak position of the (002) plane in the XRD profile was determined. The results are shown in FIGS. 6 and 7. In FIG. 6, the profile of Example 1 is 1a, the profile of Example 2 is 2a, the profile of Example 3 is 3a, the profile of Example 4 is 4a, and the profile of Example 5 is 5a. In FIG. 7, the profile of Comparative Example 2 is 2b, the profile of Comparative Example 6 is 6b, and the profile of Comparative Example 7 is 7b.

### (XRD Measurement Conditions)

Apparatus used: MiniFlex 600 produced by Rigaku Corporation
Conditions

### Light Source: Cu Tube Bulb

Characteristics X-ray: CuKα=1.54 Å
Measurement range: 2 degrees to 20 degrees (5 degrees to 20 degrees only for Comparative Example 6
Step: 50 steps/degree
Sample: Filtration film

In FIGS. 6 and 7, in Examples 1 to 5, the peak of the (002) plane is 2θ=8° or more on the high angle side, and it can be seen that the interlayer is narrowed. On the other hand, in Comparative Example 2, Comparative Example 6, and Comparative Example 7, the peak of the (002) plane was on the low angle side below 2θ=8°, and the interlayer was widened.

### (Measurement of Initial Conductivity and σ/σ₀ of MXene Film)

The initial conductivity of the obtained MXene film was determined. The surface resistivity was first measured at three points per sample, and this was defined as R₀(Ω). For surface resistivity measurement, the surface resistance of the film was measured by a four-terminal method using a simple low resistivity meter (Loresta AX MCP-T370, manufactured by Mitsubishi Chemical Analytech Co., Ltd.). In addition, the thickness (μm) was measured at three points per sample. A micrometer (MDH-25 MB, manufactured by Mitutoyo Corporation) was used for the thickness measurement. Then, the volume resistivity was determined from the obtained surface resistivity and film thickness, and the initial conductivity (S/cm) was calculated by taking the reciprocal of the value. The average value of the initial conductivities at the above three points was adopted. The results are shown in Table 3.

Similarly to the test apparatus illustrated in FIG. 5c of Document: Pristine Titanium Carbide MXene Films with Environmentally Stable Conductivity and Superior Mechanical Strength (Adv. Funct. Mater. 2020, 30, 1906996), a small amount of water was put in the bottom of a sealed desiccator, the MXene film was placed so as not to be in direct contact with the water, and held in a humid environment at room temperature and saturated in humidity for 7 days. Thereafter, the surface resistivity was measured at three points per sample in the same manner as described above, and the conductivity (S/cm) was calculated from the film thickness. The average value (σ) of the conductivities of the three points after 7 days was employed. Then, as a ratio of the average value (σ) of the conductivities after 7 days to the average value (σ₀) of the initial conductivities, (σ/σ₀)×100(%) was obtained. The results are also shown in Table 3. In this Example, the case where (σ/σ₀)×100(%) was 70% or more was evaluated as having high moisture absorption resistance and high reliability. The (σ/σ₀)×100(%) is preferably 80% or more.

TABLE 3

| | Presence | Presence | | Con- |
|---|---|---|---|---|
| | or absence | or | | ductivity |
| | of | absence | Initial | change |
| | halogen in | of | con- | rate after |
| | etching | heat | ductivity | 7 days |
| | solution | treatment | (S/cm) | (σ/σ₀) ×100 |
| Example 1 | Absence | Presence | 5800 | 95% |
| Comparative | Absence | Absence | 4300 | 66% |
| Example 1 | | | | |
| Example 2 | Absence | Presence | 6000 | 92% |
| Comparative | Absence | Absence | 4500 | 59% |
| Example 2 | | | | |
| Example 3 | Absence | Presence | 5800 | 89% |
| Comparative | Absence | Absence | 4300 | 59% |
| Example 3 | | | | |
| Example 4 | Absence | Presence | 5100 | 87% |
| Comparative | Absence | Absence | 4000 | 61% |
| Example 4 | | | | |
| Example 5 | Absence | Presence | 6900 | 89% |
| Comparative | Absence | Absence | 4400 | 69% |
| Example 5 | | | | |
| Comparative | Presence | Absence | 4900 | 26% |
| Example 6 | | | | |
| Comparative | Presence | Presence | 5000 | 39% |
| Example 7 | | | | |

From the above results, the conductive two-dimensional particle of the present embodiment does not have a large steric halogen atom (Cl, I, Br) on the surface, the MXene surface is mainly formed of small steric elements F and O, and a crosslinked structure (Ti—O—Ti) is formed. As a result, the conductive film obtained using the conductive two-dimensional particle had a narrow interlayer distance, hardly absorbed moisture, exhibited a high initial conductivity, and exhibited high reliability with a temporal change in conductivity suppressed.

The disclosure content of the present specification may include the following aspects.
<1> A conductive two-dimensional particle comprising:
a plurality of layered materials each comprising one layer or plural layers, wherein the one layer or plural layers include a layer body represented by:

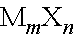

wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T existing on a surface of the layer body, wherein T is at least one selected from the group consisting of a hydroxyl group, a fluorine atom, an oxygen atom, or a hydrogen atom; and
an oxygen atom bonding a first titanium atom in the layer body of a first layered material of the plurality of layered materials to a second titanium atom in the layer body of a second layered material of the plurality of layered materials,
wherein the conductive two-dimensional particle does not contain a chlorine atom, an iodine atom, and a bromine atom, and has at least one selected from the group consisting of a fluorine atom, an oxygen atom, or a hydroxyl group.
<2> The conductive two-dimensional particle according to <1>, wherein a peak of a (002) plane exists at 2θ=8° or more in a profile obtained by X-ray diffraction measurement.
<3> The conductive two-dimensional particle according to <1> or <2>, comprising a phosphate ion.
<4> A conductive film comprising the conductive two-dimensional particle according to any one of <1> to <3>.
<5> The conductive film according to <4>, wherein a conductivity is 5,000 S/cm or more.
<6> A conductive paste comprising the conductive two-dimensional particle according to any one of <1> to <3>.
<7> A conductive composite material comprising: the conductive two-dimensional particle according to any one of <1> to <3>; and a polymer.
<8> A method for producing a conductive two-dimensional particle, the method comprising:
(a) preparing a precursor represented by:

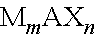

wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b) removing at least a part of A atoms from the precursor using an etching solution that does not contain a chlorine atom, an iodine atom, and a bromine atom to obtain an etched product;
(c) washing the etched product with water to obtain a water-washed product;
(d) performing an intercalation treatment with a compound for interlayer insertion, the intercalation treatment including stirring a mixed solution containing the water-washed product and the compound for interlayer insertion of the water-washed product to obtain an intercalated product;
(e) performing delamination of the intercalated product to obtain a delaminated product; and
(f) heating the delaminated product to 200° C. or higher in an inert gas atmosphere to obtain a conductive two-dimensional particle.
<9> The method for producing a conductive two-dimensional particle according to <8>, wherein the delamination of the intercalated product is performed using one or more of a polar organic dispersion medium and an aqueous dispersion medium.
<10> The method for producing a conductive two-dimensional particle according to <8> or <9>, wherein the etching solution contains at least hydrofluoric acid.
<11> The method for producing a conductive two-dimensional particle according to <10>, wherein the etching solution further contains phosphoric acid.
<12> The method for producing a conductive two-dimensional particle according to any one of <8> to <11>, wherein lithium hydroxide is used as the compound for interlayer insertion of the water-washed product.

The conductive film and the conductive paste containing the conductive two-dimensional particle of the present embodiment can be used in any suitable application, and can be particularly, preferably used, for example, as electrodes in electrical devices.

### DESCRIPTION OF REFERENCE SIGNS

1a, 1b: Layer body (MₘXₙ layer)
3a, 5a, 3b, 5b: Modifier or terminal T
7a, 7b: MXene layer
10a, 10b, 10c, 10d: MXene
21: Oxygen atom
23: Crosslinked structure
30: Conductive film
100: Conductive two-dimensional particle

1. A conductive two-dimensional particle comprising:
a plurality of layered materials each comprising one layer or plural layers, wherein the one layer or plural layers include a layer body represented by: 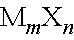
wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T existing on a surface of the layer body, wherein T is at least one selected from the group consisting of a hydroxyl group, a fluorine atom, an oxygen atom, or a hydrogen atom; and
an oxygen atom bonding a first titanium atom in the layer body of a first layered material of the plurality of layered materials to a second titanium atom in the layer body of a second layered material of the plurality of layered materials,
wherein the conductive two-dimensional particle does not contain a chlorine atom, an iodine atom, and a bromine atom, and has at least one selected from the group consisting of a fluorine atom, an oxygen atom, or a hydroxyl group.

2. The conductive two-dimensional particle according to claim 1, wherein a peak of a (002) plane exists at 2θ=8° or more in a profile obtained by X-ray diffraction measurement.

3. The conductive two-dimensional particle according to claim 2, the peak of the (002) plane exists at 2θ=8° to 9° in the profile obtained by X-ray diffraction measurement.

4. The conductive two-dimensional particle according to claim 1, further comprising a phosphate ion on a surface of the conductive two-dimensional particle.

5. The conductive two-dimensional particle according to claim 1, wherein M is at least one selected from the group consisting of Ti, Zr, Hf, V, Nb, Ta, Cr, Mo, and Mn.

6. A conductive film comprising the conductive two-dimensional particle according to claim 1.

7. The conductive film according to claim 6, wherein the conductive film has a conductivity of 5,000 S/cm or more.

8. A conductive paste comprising the conductive two-dimensional particle according to claim 1.

9. A conductive composite material comprising:
the conductive two-dimensional particle according to claim 1; and
a polymer.

10. A method for producing a conductive two-dimensional particle, the method comprising:
(a) preparing a precursor represented by: 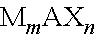
wherein M is at least one metal of Group 3, 4, 5, 6, or 7,
X is a carbon atom, a nitrogen atom, or a combination thereof,
A is at least one element of Group 12, 13, 14, 15, or 16,
n is 1 to 4, and
m is more than n and 5 or less;
(b) removing at least a part of A atoms from the precursor by using an etching solution that does not contain a chlorine atom, an iodine atom, and a bromine atom to obtain an etched product;
(c) washing the etched product with water to obtain a water-washed product;
(d) performing an intercalation treatment with a compound for interlayer insertion, the intercalation treatment including stirring a mixed solution containing the water-washed product and the compound for interlayer insertion of the water-washed product to obtain an intercalated product;
(e) performing delamination of the intercalated product to obtain a delaminated product; and
(f) heating the delaminated product to 200° C. or higher in an inert gas atmosphere to obtain a conductive two-dimensional particle.

11. The method for producing a conductive two-dimensional particle according to claim 10, wherein the delamination of the intercalated product is performed using one or more of a polar organic dispersion medium and an aqueous dispersion medium.

12. The method for producing a conductive two-dimensional particle according to claim 10, wherein the etching solution contains at least hydrofluoric acid.

13. The method for producing a conductive two-dimensional particle according to claim 12, wherein the etching solution further contains phosphoric acid.

14. The method for producing a conductive two-dimensional particle according to claim 10, wherein lithium hydroxide is used as the compound for interlayer insertion of the water-washed product.
